(19) United States
(12) Patent Application Publication
(10) Pub. No.: US 2012/0109953 A1
(43) Pub. Date: May 3, 2012

(54) System and Method for Modeling Human Experiences, and Structuring and Associating Experience Information so as to Automate the Production of Knowledge

(76) Inventor: Stephen P. Brown, Waukesha, WI (US)

(21) Appl. No.: 13/281,917

(22) Filed: Oct. 26, 2011

Related U.S. Application Data
(60) Provisional application No. 61/455,822, filed on Oct. 27, 2010.

(51) Int. Cl. G06F 17/30

(52) U.S. Cl. 707/736; 707/E17.045

(57) ABSTRACT

The present invention creates a system for describing human experience, and creating, accessing and analyzing information that allows human experiences to be shared, compared, and analyzed. An Experience is described using Condition (C), Objective (O), and Strategy (S) attributes. Data is identified or tagged using C, O and S attributes, allowing the data to be combined to describe an experience, then making it searchable in such as way so that highly relevant information is selected, organized, and presented to the user. The system allows multiple individuals to share their experience data so that individuals can compare experiences, and make more informed choices. A system composed of experience databases, an individual's current needs, and automated computer agents, is presented to search for, select, display and update highly relevant information to the user as the user's situation changes, making information self-organizing, and automating the production of knowledge and taking actions based thereon.

### CROSS-REFERENCE TO RELATED APPLICATIONS

This application claims the benefit of U.S. provisional patent application No. 61/455,822, which was filed on Oct. 27, 2010 and entitled “Method and System for Organizing Information to Enhance Decisionmaking”, and which is hereby incorporated by reference herein.

### BACKGROUND OF THE INVENTION

Information is currently made available to people as isolated facts, and assembled into information in a way intended by the originator or author of the information. Yet people typically search for information in order to obtain answers to questions that are specific to the context of their current experiences. For example, one searches for answers to questions such as the financial return on a mutual fund, or advice on how to allocate assets within a retirement fund, based on the individual's personal assessment of their own presumed needs. These needs are typically a function of the person's financial situation, and their plan for the future. Rarely is information from the World Wide Web, for example, selected, organized and presented in a way that is directly relevant to the user's personal situation.

The individual who attempts to assess their own needs and create their own investment goal and plan may, but often does not, know what questions to ask in order to properly evaluate their needs, or formulate achievable goals, or create a workable plan to obtain the goal. As a result, the individual spends considerable time searching for information, hoping to assemble the data necessary to make effective decisions, while not knowing specifically for which information they should be searching.

The advent of the internet has facilitated to some extent the ability of individuals to ferret out for themselves answers to their questions. Yet information available via the internet is often structured in ways that make it difficult to assemble and aggregate. Information gathered and published by one institution is often not comparable with information published by another institution. Information about multiple individuals' experiences is neither easily aggregated nor easily shared. The result is wasted time, and suboptimal decisions, due to ineffective and time consuming searching, and difficulty analyzing the information obtained.

Although the consultation of experts constitutes an alternative for persons who seek answers or solutions to their questions, needs, or problems, there are significant limitations that restrict the ability of experts within a variety of fields to reliably, promptly, and efficiently address problems of their clients. Not only is expert advice costly, reflective of the significant training and expertise of the expert in question, but also obtaining expert advice can be an inefficient and time-consuming process that involves having the experts asking their clients many questions and obtaining and considering a wide variety of information, so as to assess the client's true needs as measured along a set of relevant characteristics and to make recommendations. For example, a financial expert can have developed a set of key indicators which are used to properly assess the client's current situation, and identify or create a set of obtainable investment goals from which the customer can choose. From this analysis, and by utilizing many different data sources describing currently available investments, an investment plan can be developed, specifically tailored to the individuals needs. Other experts, such as legal or medical experts, will leverage their extensive formal and ongoing training and experience to understand their client or patient's current situation and render recommendations.

Additionally problematic is experts have developed and constantly rely on their personal knowledge of others' experiences, formulated as (i) classical training in best practice and state of the art knowledge, or as (ii) recent trends and new developments as reported about other individuals, and can use that experiential data to ascertain an individual's needs, determine their goals, and recommend a plan or set of choices and actions as necessary to achieve the goal. Yet such significant reliance placed on other individual's experiences can be undesirable for example, since it may be difficult to ascertain the exact pertinence or relevance of other individuals' experiences. For example, in the medical field, it is difficult for a doctor to obtain real time data about the set of all patients who have presented to a doctor with a condition similar to the patient's, and assess the appropriateness of the various treatment protocols used to treat the set of all patients with that condition, in order to evaluate the effectiveness of each protocol can be providing. Also it is difficult for a doctor to evaluate the particular pertinence of studies indicating the ability of a specific new drug to treat people with a specific condition. Thus in some circumstances doctors may be using incomplete and obsolete information to recommend treatments protocols to their patients. Therefore, even with all of their expertise and all of the strategies available to them, unfortunately the pursuit of expert advice nonetheless involves passing a wide variety of hurdles.

In view of the above, therefore, it would be advantageous if a system and/or method could be developed that facilitated the capability of people to obtain answers to their questions and/or solutions for their needs/problems, and/or that addressed one or more of the above-discussed concerns and/or other concerns.

### SUMMARY OF THE INVENTION

The present inventor has further recognized that existing systems and methods and technologies available to individuals for answering their questions and for providing solutions to their problems are ill-suited for enabling individuals to effectively address the issues at stake and efficiently find the information they seek. Most individuals are not experts, and can spend considerable time searching for answers to questions which are irrelevant to their needs, because they are unable to properly diagnose those needs. Individuals attempting to make decisions without the guidance of experts are constrained by an inability to search for and find adequate guidance from the poorly structured and incomplete information available using current methods. Yet the present inventor also has recognized the difficulties faced by individuals in turning to experts for answers and solutions to their questions, needs, and problems.

In further considering these issues, the present inventor has further recognized that people commonly deal with three types of problems: those for which we do not know our objective, those for which we do not know our current condition, and those for which we do not know the strategy to get from our condition to the objective. Relatedly, the present inventor has recognized that, in general, a model of human experience (the ‘C—O—S Experience Model’) can be defined as comprising a Condition element (C, or initial state), an Objective element (O, or the state which is to be achieved), and a Strategy element (S, or the action or actions necessary to achieve a specific Objective from a specific Condition), where a specific completed Experience (E) is one in which an individual started at a specific Condition, and achieved a specific Objective, via a specific Strategy. Further, the present inventor has recognized that it is achievable to create systems and/or methods that can facilitate the obtaining of answers/solutions to questions/problems/needs by basing operation of such systems and/or methods upon an assumption that human experiences can reliably be modeled in this manner.

Thus, in at least some embodiments, the present disclosure relates to a system for modeling human experiences, allowing multiple individuals' experiences to be described in such a way so as to enable information about those experiences to be easily identified, assembled, and summarized for effective analysis and decision making. Further, an individual looking to solve a specific problem can, using this system, more easily search for, find, aggregate and apply highly relevant information by searching for information explicitly related to his or her immediate need. Also, in at least some embodiments, an individual's current experiential state can be described using an incomplete set of experience elements (for example, having started at a given Condition, and having chosen to employ a specific Strategy, but not yet having completed the intended Objective, or having specified an initial Condition, and a desired Objective, but not having chosen a specific Strategy to achieve the Objective).

Additionally, in at least some embodiments, the system captures a completed Experience upon achieving an Objective (O′), then updates the person's Condition from the original Condition (C′), to that new Condition (C″) which resulted from the movement from the original Condition (C′) to the original Objective (O′). The original Objective is now the new Condition. O′═C″. Further, at least some additional embodiments describe a complex experience using a set of sub-experiences. For example, a more complex project, such as building a house, can be decomposed into a set of interrelated sub-experiences that make the higher level project easier to model and manage. Further for example, sub-experience 1 may be to select a lot on which the house will be build, followed by step 2 which would be to obtain necessary permits, which depend on the exact location of the lot, and therefore cannot be fully predicted before the lot is chosen. In such an alternative embodiment, a multi-phased experience can be modeled, yet allow future sub-experiences to be based on or made dependent on the exact, as yet unpredictable, outcome of an earlier sub experience.

In at least some embodiments, the present disclosure relates to a system, method and/or process for indexing information, by associating metadata attributes (tags) to data points, which can be comprised of any form of information, physically or electronically stored, including but not limited to entire or partial documents, email's, web pages, images, text, tweets, maps, videos, music, and books. The tagged data points describe a Condition, Objective, and/or Strategy, with C, O and S attributes or tags so as to make the information items findable by searching for the items based on their C or O or S tag values. Information tagged with C or O or S tags is called experiential information. Tags can be created manually and explicitly by the individual, or automatically through computer agents and/or computer applications which interpret the content of information items and apply C, O and/or S tags autonomously.

Additionally in at least some embodiments, the system allows an individual who has specified their experiential state, or a hypothetical experiential problem to be solved, to manually initiate a search, or create computer agents to automatically initiate a search, to obtain experiential information from various sources, locally or distributed across public or private computer networks, such information being selected based on the extent to which the experiential information matches or aligns with one or more of the individual's specified experience elements. Also, in at least some embodiments, by using the C—O—S model to (i) capture a person's current experiential state or specify a hypothetical experiential problem to be solved, and (ii) structure or index information so as to be able to select only that specific information which aligns to the individual's experiential state, there is created a method which enables a computerized information system to present information to the individual which is more relevant than data typically obtained using existing search mechanisms, because the information is directly applicable to the individual's specific situation and needs.

Also in at least some embodiments, as an individual completes an Experience, the system stores the completed Experience in a database. Further, as an individual completes an Experience, the invention recognizes movement to a new experiential state, and, responding either to an individual's explicit instruction, or to preprogrammed software agents, initiates a search and re-obtains new experiential information aligned with the new state, and presents the new highly relevant information to the individual. In this manner, information self-organizes according to the needs of the individual as the individual's experiential state changes, automatically producing knowledge, which can be defined as information specifically relevant and applicable to the individual based on that individual's specific situation.

Further in at least some embodiments, as multiple experiences are completed by an individual, a database of that person's completed C—O—S Experiences is built. Multiple persons' C—O—S Experiences can be consolidated into a single database or linked over a computer network. Experience databases can be made freely available and shared with select other individuals, or anyone, at no cost to others, or can be published and a fee charged to others for access to the database. Sharing and comparing multiple persons' experiences creates a powerful tool to organically derive the optimal strategy for any situation, allowing a person to more easily identify the options available in a given situation based on the experiences of others who have been in the same condition, thereby providing context-specific information, enabling the person to make better decisions.

Further, in at least some embodiment, the present disclosure relates to a method of developing knowledge. The method includes receiving at a computer system first information provided by at least one actor identifying a plurality of primary elements, and receiving at the computer system second information provided by the at least one actor, wherein the second information categorizes each of the primary elements as having a respective primary attribute. The method also includes receiving at the computer system third information provided by the at least one actor, wherein the third information establishes relationships between at least some of the primary elements so as to define one or more primary experiences. Each of the primary experiences includes respective first, second, and third ones of the primary elements and is representative of a respective movement or progression between the respective first of the primary elements to the respective second of the primary elements via the respective third of the primary elements. Also, the respective primary attribute of each of the first primary elements is a respective condition attribute, wherein the respective primary attribute of each of the second primary elements is a respective objective attribute, and wherein the respective primary attribute of each of the third primary elements is a respective strategy attribute. Further, the method also includes storing the one or more primary experiences within a database at least indirectly associated with the computer system.

Additionally, in at least some embodiments, the present disclosure relates to a computer system. The system includes a memory including at least one database, and at least one user interface. The system also includes at least one processing device that is at least indirectly in communication with the at least one database and the at least one user interface. The computer system is configured to receive, via the at least one user interface, input information including first instructions to tag respective information items as being or including respective condition, strategy, or objective attributes, and second instructions to establish relationships among several of the attributes so as to define first experiences. Additionally, each of the defined first experiences is stored in the at least one database, and is representative of a movement or progression from a respective condition attribute to a respective objective attribute via a respective strategy attribute. Further, upon the computer system receiving an additional input indicative of a second experience or portion thereof, the at least one processing device is configured to search the at least one database to achieve a search result including at least one of the one or more first experiences having at least one information item that is also found in the second experience or portion thereof, to analyze the search result, and to generate an output to be provided by the at least one user interface.

### BRIEF DESCRIPTION OF THE DRAWINGS

FIG. 1 is a C—O—S model of a human experience;

FIG. 2 is a functional block diagram of the Experience Advisor System;

FIG. 3 is a data model diagram illustrating how an experience is composed of condition, strategy and objective elements, each of which are composed of data points comprising explicitly entered data and/or data stored externally and linked to by the system;

FIG. 4 is an example user interface within the Experience Advisor system used to explicitly create and save Experience data;

FIG. 5 is an example flow chart of a user and/or an agent interacting with the Experience Advisor system to select, tag, associate and store experience data directly from external raw data sources;

FIG. 6 is an example user interface within the Experience Advisor System to search for, select, and share experiences with others;

FIG. 7 is an example flow chart of user interacting with the Experience Advisor to search for others' experiences, and save and/or perform an analysis;

FIG. 8 is a schematic diagram illustrating one possible Experience Analysis display result;

FIG. 9 is an example flow chart of a user or agent updating the condition of an experience, and initiating a new search;

FIG. 10 is a schematic diagram illustrating one example of how an experience can be made up of multiple sub-experiences;

FIG. 11 is a schematic diagram illustrating one example of how a user interacts with the Experience Advisor System to progress from one sub-experience to another;

FIG. 12 is an example flow chart of an agent-based process for analyzing an experience and recommending that more detail be added to an existing experience, in order to compare it to others.

### DETAILED DESCRIPTION OF THE INVENTION

The present disclosure relates to systems, such as computer-based systems, and related processes to model human experiences, and analyze and compare experiences so as to assist users in making better decisions. At least some embodiments of such systems and/or processes will be described in detail with reference to example embodiments of purchasing a car, maintaining a home, a doctor treating a patient, and attending a music concert. However, reference to these specific embodiments does not limit the scope of application of the disclosure. It should be recognized that the subject matter discussed herein and related components and processes can be applied to many applications and situations, including but not limited to the fields of law, business, maintenance of capital equipment, managing any multi-step project, knowledge management within consulting and services businesses, strategic planning, personnel objective setting, career development, personal effectiveness coaching, and selecting the most popular local restaurant. Indeed, embodiments as disclosed and/or envisioned herein can be applied to any area of human endeavor in which experiences of other individuals can be used to guide us and help us make better choices.

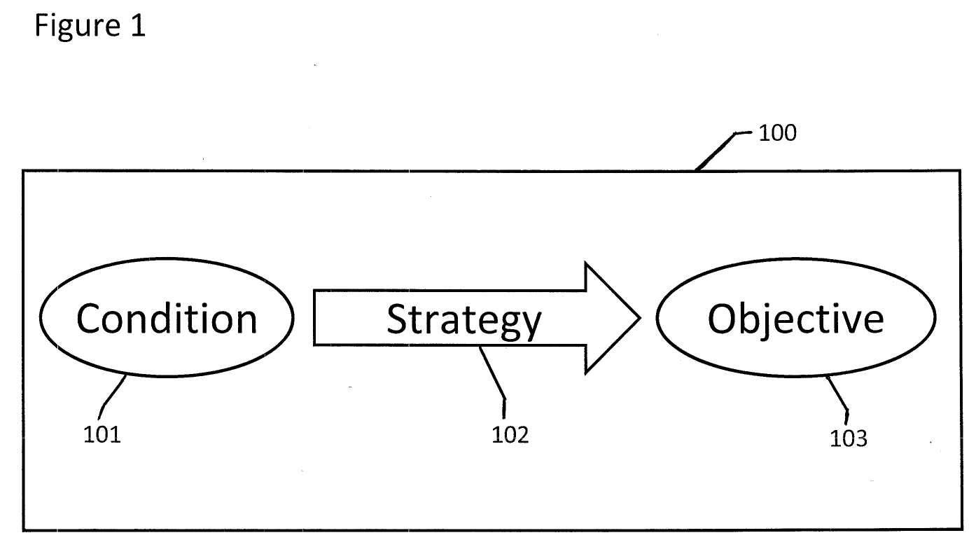

FIG. 1 illustrates the C—O—S model of a human experience 100, describing the experience as composed of 3 specific experience elements, which include an initial state, called a Condition (C) 101, a final or desired state called an Objective (O) 103, and the action or plan, called a Strategy (S) 102, used by the individual to move from the specific Condition and achieve the specific Objective. An Experience in accordance with the C—O—S Experience Model 100 is the movement from a Condition 101, via a Strategy 102, to an Objective 103. It should be appreciated that the C—O—S Experience Model 100 shown in FIG. 1 is an abstraction or means for conceptualizing experiences generally, and any given experience with a particular respective Condition 101, Strategy 102, and Objective 103 will be an instance of the model. By virtue of defining experiences in accordance with the C—O—S Experience Model 100, analysis of related experiences can be achieved so as to determine useful results.

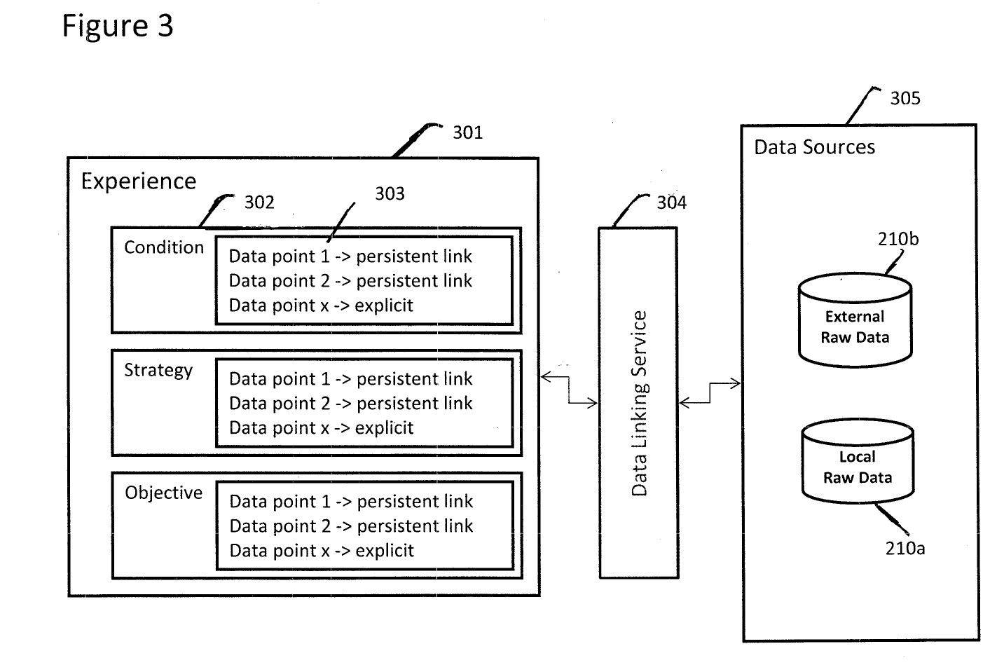

For example, an individual who presented to a medical doctor with atrial fibrillation, who had a given age, blood pressure and other data points of medical history (Condition 1), was treated using catheter ablation (Strategy 1), and achieved a positive outcome with minimal side effects (Objective 1). In contrast, a different individual presented to a different doctor with the identical atrial fibrillation Condition (Condition 1), however in this second case the doctor recommended instead a combination of drugs (Strategy 2), and achieved a different outcome due to side effects which harmed the patient's quality of life (Objective 2). These two experiences, represented in accordance with the C—O—S Experience Model 100, can be directly associated and compared by virtue of the fact that they share an identical starting Condition, Condition 1. A set of such experiences can be analyzed to indicate the relative effectiveness of the alternative Strategies (Strategies 1, 2, 3, . . . n) employed by all those individuals who began with a similar Condition 1, and the results or Objectives achieved by those individuals (Objectives 1, 2, 3, . . . n). Further details regarding how experience instances in accordance with the C—O—S Experience Model 100 can be formulated and utilized are discussed below, including with respect to FIG. 3

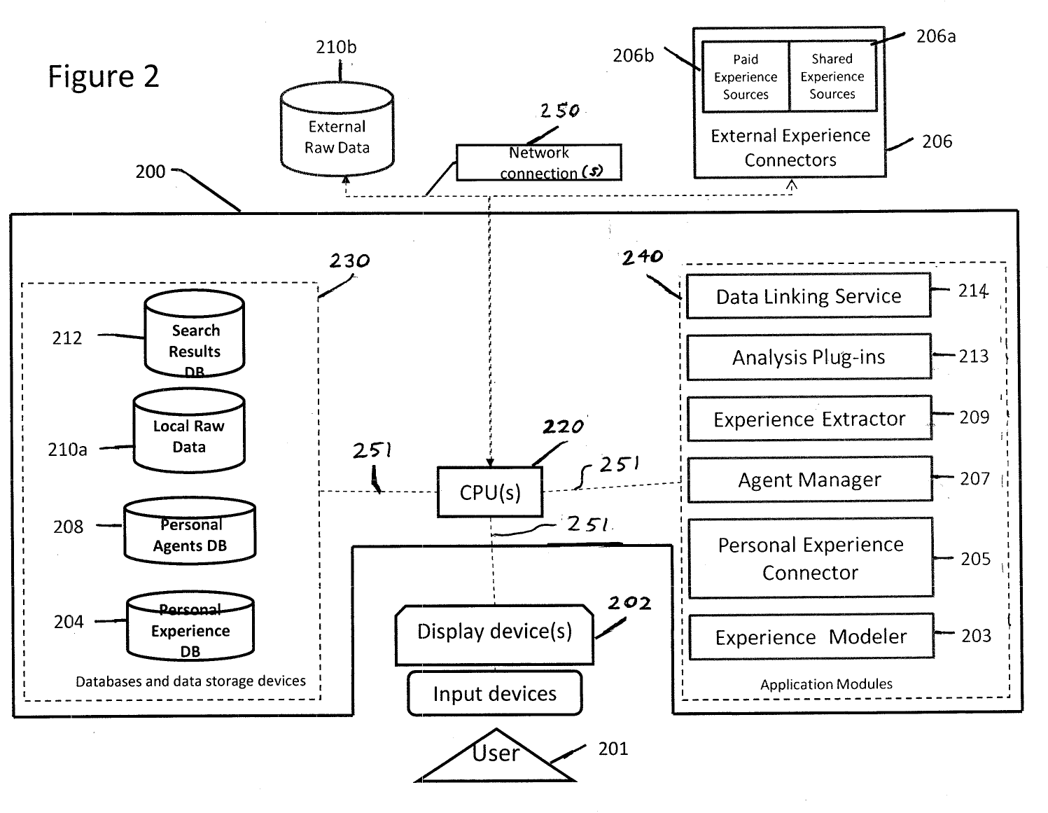

FIG. 2 illustrates the Experience Advisor System 200. The Experience Advisor System 200 in at least some embodiments includes a set of software application modules or services 240 that run on (e.g., are executed by) one or more local or remote computing machines and/or processing devices represented in FIG. 2 as central processing unit(s) (CPU(s)) 220. Although FIG. 2 particularly shows the CPU(s) 220, it should be appreciated that the CPU(s) are intended to be representative of any number(s) of any of a variety of different types of computing machines/processing devices including for example a computer, a network device, cellular phone, personal digital assistant, tablet computing device, manufacturing tool, or any device with one or more processors. The software application modules or services 240 (which in the present embodiment are shown to include modules 203, 205, 207, 209, 213, 214 discussed further below) are not required to be implemented within any specific programming language, and can be implemented using one or any combination of computing devices, including general computing devices, special purpose devices such as application-specific integrated circuits, programmable logic device, field-programmable gate arrays.

Further as shown, the CPUs 220 are connected to one or more local or remote display and input devices 202 and also to one or more local and/or remote data storage devices by way of various network connections and communication links, including in this embodiment both communication links external to the System 200 shown as network connection(s) 250 and also communication links internal to that System shown as communication link(s) 251. In the present embodiment, the storage devices of the System 200 include databases 204, 208, 210a, 212, which are in communication with the CPU(s) by the communication links 251. Also in the present embodiment, the storage devices with which the CPU(s) 220 are in communication, via the network connection(s) 250 (which can operate via network protocols), include external data storage devices 210b. Additionally as shown, the CPU(s) 220 in the present embodiment also can engage in communications with External Experience Connectors 206, also by way of the network connection(s) 250. The External Experience Connectors 206 are intended to be representative of any of a variety of different types of external machines/devices capable of performing computing/processing and/or data storage and, in at least some embodiments, one or more of the External Experience Connectors include one or more additional Experience Advisor Systems similar or identical to the Experience Advisor System 200, one or more of which can be operated or intended for operation by or in conjunction with other user(s) and/or entities, and/or one or more portions of such systems (such as respective Personal Experience Connectors modules corresponding to the module 205 of the Experience Advisor System 200 described in further detail below).

Although for simplicity the display and input devices 202 are shown in FIG. 2 as being in communication with the CPU(s) 220 by way of the communication links 251, it should be appreciated that in some embodiments, particularly where one or more of the display and/or input device(s) 202 are remotely located relative to the location of the remainder of the Experience Advisory System 200, such communication links can also include communication link portions similar or identical to those of the network connection(s) 250. Also it should be appreciated that the display and input devices 202 can also, in other embodiments, include a wide variety of types of devices that allow for interfacing/intercommunications with users and other entities, including a variety of devices that allow for any of variety of input and/or output operations to occur.

In the present embodiment, the user 201 accesses the Experience Advisor System 200, and the multiple software application modules or service contained within the system 240 (e.g., applications 203, 205, 207, 209, 213, and 214), via a user interface 202. In at least some embodiments the user interface 202 can be displayed on one or more of many types of display devices, such as a computer monitor, a television screen, a personal digital assistant, a mobile phone, or other devices intended to communicate information generated by the System's computing device or devices to a human user, such a user interface being generated by the System 200 running on one or more computing devices connected directly to or part of the display device, or being served by one or more computing devices connected to the display device via one or more wired or wireless network connections as described in detail below. In the present embodiment of the Experience Advisor System, the user interface is particularly configured to facilitate accessing of and interaction with the System by human beings who are users of the system. However, it should also be appreciated that the Experience Advisor System can also include user interfaces such as application programming interfaces that enable or facilitate interactions with other computer systems and/or programs that can operate as actors, such as agents as discussed below.

Given the wide variety of computer system architectures available, the system may be implemented entirely as a single hosted application, or can be distributed across multiple processors and data storage devices via such methods as a Services Oriented Architecture (SOA) and/or remotely hosted application servers, connected via multiple networking, application and communication protocols, receiving input from and serving display information to a user situated at local display and input devices, or remote display and input devices via a network connection. The system is also architected so as to allow the services and data to be embedded wholly within a 3^{rd} party application, performing functions which are then provided to a user within the context of the 3^{rd} party application's system and user interface.

Referring to FIG. 2, the components of the Experience Advisor System 200 in the present embodiment include several application modules or services 240. The application modules/services 240 can be further understood to be programs that are operating on the CPUs 220. Notwithstanding the present discussion, it should be appreciated that, depending upon the embodiment, one or more of these specific application modules need not all be present and/or one or more other application modules can instead or in addition also be present.

The Experience Modeler application module or service 203 allows a user and/or agent to select raw data elements, assign or tag data elements with tags indicating that the data represents a condition, strategy or objective element of an experience, and associates the tagged elements together to describe experiences. In circumstances where data elements are already tagged as being Conditions, Objectives, or Strategies, the Experience Modeler application module also facilitates selection from among such tagged data elements.

The Personal Experience Connector application module or service 205 enables or facilitates (e.g., by way of a user and/or one or more agents) the selection of experiences stored in the user's database, and then allows the user to (a) search for and collect other experiences which match, by way of user specifiable criteria, one or more of the selected experiences' condition, strategy or objective attributes, or (b) make the user's experiences sharable to others by specifying one or more criteria by which the System grants a second actor access to the experience data 204 stored by the System 200. The user specifiable criteria used to indicate a match include but are not limited to such methods as specifying a range of numerical values, or a list of values such as a list of synonyms, or may utilize a predefined taxonomy of terms specifying sets of values for an attribute which are considered to qualify as a match. The Personal Experience Connector 205 allows for interactions with the External Experience Connectors 206 (available over one or more of the network connection(s) 250, described in further detail below) which in at least one embodiment are comprised of the Personal Experience Connectors of other Systems, and thus allows a user or other actor, by means of user selectable alternatives, to obtain information from, publish or otherwise make available to, and to establish and maintain relationships with, databases of experiences maintained and shared or published by others.

The Agent Manager application module or service 207 creates, maintains, edits, and manages software agents. For purposes of the present discussion, a software agent is an autonomous or stand-alone computer application capable of goal seeking behavior. Agents act for a user or other program in a relationship of agency, and are capable of making decisions on behalf of the user or on behalf of another program, system, or actor. They can work independently or in combination with other agents. They can also adapt their behavior based on changing and unforeseen conditions. Agents can be programmed with a goal such as to find specific information, continuing to search until the information is found. In at least some embodiments the Agent Manager 207 creates and maintains software agents capable of performing the tasks which a user (or other actor) could otherwise perform while interacting directly with the application modules or services of the Experience Advisor System 200.

The Experience Extractor application module or service 209 accesses data, either locally stored or contained in 3rd party software applications and/or their associated databases and, using predefined algorithms and translators specifically written for specific 3rd party applications and/or databases, translates or interprets the raw data so as to indentify and extract that data which is representative of condition, strategy or objective elements, and/or tags the raw data appropriately, and/or associates the tagged data elements into experiences, and/or saves the experiences in the personal experience database 204. Multiple Experience Extractors are made available so as to respectively interface with, access, translate, and interpret the data stored in multiple 3rd party software applications and their associated databases, respectively. For example, the Experience Extractor can serve as a translator (e.g., as part of an application program interface or API) that allows for experience information (e.g., various medical experience information) from different sources to be properly accessed and interpreted by the Experience Advisory System 200 notwithstanding differences in the operations/formatting of the different sources of experience information.

The Analysis Plug-in application module or service 213 analyzes experiences. Multiple Analysis Plug-ins contain algorithms so as to evaluate experience data using methods specific to a given domain of human endeavor, such as finance, medicine, law, construction, etc., making those specific analytical methods available to a user to analyze selected experiences. As alternative example embodiments, multiple models exist to analyze portfolios of investments, and standard project plans exist to manage the process of building a home. In at least one embodiment, third parties can create and offer for sale Analysis Plug-ins 213 to enable the System 200 to integrate the advanced analytical formulas and expert reasoning processes developed by other experts.

The Data Linking Service application module or service 214 establishes and maintains connections between the databases that store experiences, and the raw data from which the experiences are built, so as to allow the experiences to update, if and when the values of the raw data underlying the experience change. Although such connections can be persistent, the connections can also be intermittent or periodic depending upon the embodiment or circumstance. The Data Linking Service 214 establishes a connection between experience data elements such as those stored in the Personal Experience database 204 or External Experience Databases 206a 206b, and raw data, such as that stored in one or more local raw data databases 210a or databases of raw data 210b stored external to the System yet made accessible to the System via one or more network connections 250.

Further to FIG. 2, in the present embodiment, the Experience Advisor System 200 also includes multiple databases 230 as shown and discussed further below. Although the present embodiment of FIG. 2 shows four databases in particular, the number and arrangement of databases can vary depending upon the embodiment, and the type(s) of information stored on any given database can also vary with the embodiment or circumstance. Although not shown, it should also be appreciated that the Experience Advisor System 200 will include or be associated with one or more memory portions on which are stored programming code for operating the applications/services described above (e.g., 203, 205, 207, 209, 213, 214 and/or others).

The database of Personal Experiences 204 stores experiences, and their respective experience elements and data points, created by and/or acquired by the user.

The database of Personal Agents 208 is comprised of those software agents created by, and/or maintained by the user, which includes software programs that govern and determine operation of such agents (e.g., including programming as to how the agent is used or implemented).

The one or more databases of locally stored raw data 210a or remotely stored raw data 210b are accessed by the user (or other actor) and the user's Experience Advisor system (e.g., by way of the Experience Extractor 209 and/or the Data Linking Services 214), from which experience elements and experiences are created.

The database of Search Results 212 is used to store results of searches performed by the System 200, and compare the results of searches repeated at different times.

The Experience Advisor System 200 in at least one embodiment is designed to utilize network connections 250 to access and share data with other systems via standard local and wide area network connections and protocols. The network connections 250 can be intranet, internet and/or extranet networks established using one or more or a combination of methods such as wired, wireless, synchronous optical networking, bus, microwave or ratio connections, using one or more or a combination of protocols such as HTTP, Ethernet, the Internet Protocol Suite including TCP/IP, over one or more or a combination of network types including personal, local, home, wide area, public, private, enterprise private, virtual private, storage area, backbone, public switched telephone, and/or overlay networks (e.g. peer-to-peer), by way of one or more or a combination of conventional or other specialized networking hardware such as network interface cards, repeaters, hubs, switches and routers. In this way, the Experience Advisor System 200 can access externally stored data 210b, and other Experience Advisor Systems (e.g., ones of the External Experience Connectors that themselves constitute other Experience Advisor Systems) 206, including those systems' experience databases 206a and 206b and can connect one or more display and input devices to one or more CPU's.

FIG. 3 is a schematic diagram illustrating in further detail how numerous Experience Data Elements (or simply “Experience Elements”) 302, conceptualized or formatted in accordance with the C—O—S Experience Model 100 of FIG. 1, form an Experience 301 that is an instance of the C—O—S Experience Model. Also, FIG. 3 illustrates in further detail how the Experience Data Elements 302 forming the Experience 301 can be stored and/or utilized. As already described, in the present embodiment, the organization of the Experience Elements 302 in accordance with the C—O—S Experience Model 100 underlies all of the Experiences 301 created by the Experience Advisor System 200. The C—O—S Experience Model 100 specifies that each Experience 301 is composed of Experience Elements 302 representing a Condition 101, a Strategy 102, and/or an Objective 103.

As shown in FIG. 3, each Experience Element 302 of each Experience (of which the Experience 301 is merely one example) is itself made up of one or more data points 303 that describe the Experience Element in detail. In the present embodiment, each data point 303 contains the name of the data point, the current value of the data point, and an indication of whether the data value was entered explicitly by the user, or is data contained in a 3^{rd} party system to which the data point is linked via the Data Linking service 304. In the example of FIG. 3, each of the Experience Elements 302 is shown to include a respective set of three of the data points 303, namely, a Data point 1, a Data point 2, and a Data point x. Nevertheless, it should be understood that any given Experience Element can include any arbitrary number of Data points (indeed, this should already be apparent from FIG. 3 to the extent that the third Data point of each set is labeled “Data point x”), and different Experience Elements of a given Experience need not have the same number of data points. And it is of course envisioned that, even though only the single Experience 301 is shown in FIG. 3, in practice the Experience Advisor System 200 will store, have access to, modify or otherwise process, and otherwise interact with a great multitude of Experiences (e.g., even millions or billions of Experiences).

As shown in FIG. 3 (and as also consistent with FIG. 2), communications between the Experience Advisor System 200 and the data sources 305 occurs by way of the Data Linking Service 304, while communications with database(s) internal to (associated with) the Experience Advisor System such as personal experience database 204 of FIG. 2 need not occur via the Data Linking Service. The Data Linking Service 214, 304 particularly can allow for the establishing of relationships between the Experience Advisor System 200 and external systems such as databases, local or remotely stored data and files, or data served by web or other data servers 305, such as those represented in FIG. 2 as local raw data 210a and external raw data 210b, so as to allow for ongoing and/or real-time updating of one or more of the Data points 302. That is, when particular ones of the Data points 303 are based upon third party information, the Experience Advisor System 200 allows for the possibility that the data points will change over time based upon changing third party information as provided via the Data Linking Service 304, which maintains persistent relationships with one or more of the Experience Elements 302 (e.g., data elements that have been selected by a user). Such relationships can in some embodiments be achieved via standard methods such as subscription, so that a change in the value of the underlying data point is recognized by the Data Linking Service and communicated via standard protocols to the Experience Modeler 203.

Further in this regard, in the present embodiment as shown in FIG. 3, particular ones of the Data points 303 (of particular ones of the Experience Elements 302) are specified as being Data points that are explicitly defined (e.g., by a user of the Experience Advisor System 200) or as being determined based upon third party information. For example, each of the Condition Data point 1, Condition Data point 2, Strategy Data point 1, Strategy Data point 2, Objective Data point 1, and Objective Data point 2 of FIG. 3 is indicated as being persistently linked with one (or more) of the data server 305 via the Data Linking Service 304 and thus these data points can change automatically over time as information is received via the Data Linking Service 304. Assuming this to be the case, it can be understood that the values of these ones of the Data points 303 are updated over time based upon data received via the Data Linking Service 304. By contrast, the Condition Data point x, Strategy Data point x, and Objective Data point x, are data points that have been explicitly set by way of user (or other actor) input, and are not updated in this manner. Also, it can be noted that communications via the Data Linking Service 304 need not be persistent, but rather in alternate embodiments can be otherwise (e.g., temporary, intermittent, or periodic).

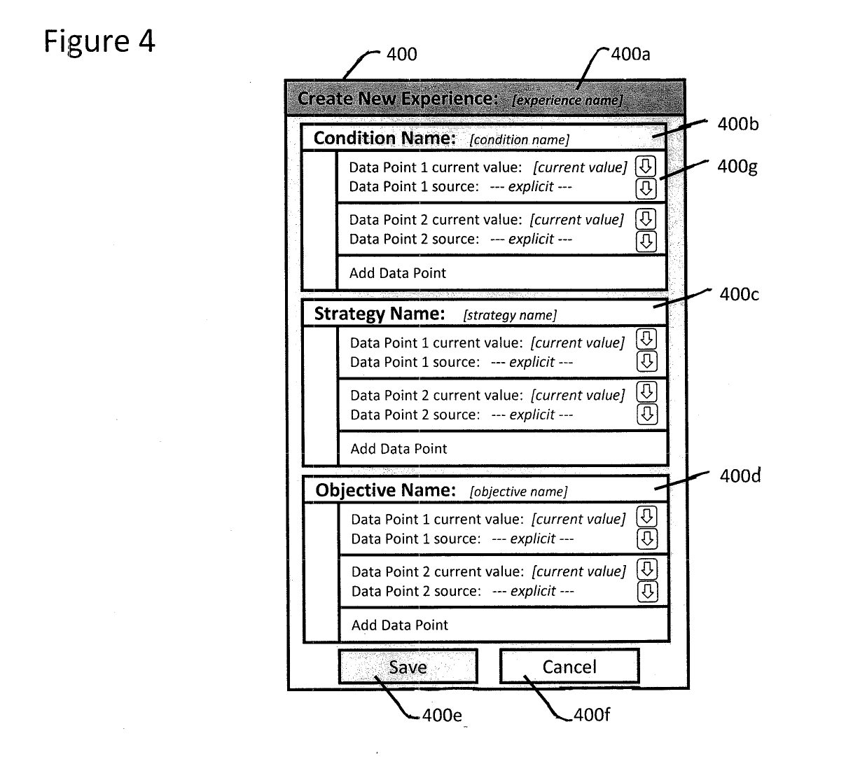

FIG. 4 illustrates an example of a basic data entry menu 400, available from within the Experience Advisor system 200, to illustrate how in one example embodiment the system accepts input from the user to capture the relevant experience data 301, 302, 303 directly, and store that as a completed Experience 100, 301 in a Personal Experience database 204. The menu 400 shown can be considered to constitute a screen shot or example version of a user interface that can appear or be provided to a user via one or more of the display devices 202 by which the user can interface the Experience Advisory System 200. A detailed flow chart (or workflow) narrative of how the system would interact with the user via the Create New Experience menu 400 is as follows:

System 200 presents the user with the New Experience Creation window 400. The window contains fields enabling the user to enter an Experience Name 400a, and areas for entering data for each of the 3 experience elements: Condition 400b, Strategy 400c and Objective 400d, and buttons which will execute commands to Save the data 400e or Cancel the operation 400f. Within each element area, there are user entry fields for multiple data points 400g, numbered 1 through n, each containing fields for the current value of the data point, and the data source from which the value is derived. The system also provides pull-down arrows to allow the user to search within a list of values for each data point value and source so as to reuse existing taxonomies or a standard list of values, and the option to add additional data points within each element.

As one example embodiment, the user begins by entering ‘treat high blood pressure’ as the experience name 400a.

The user then moves the cursor into the Condition element area 400b, and enters ‘high blood pressure’ as the name of the Condition element. The user then moves to Data Point 1 400g, and in the [current value] field enters ‘155/98’. The user leaves the data source field value as its default value of ‘explicit’, meaning the data came from the user's direct entry of the value.

The user then moves to the Strategy area 400c. The user enters the strategy name ‘beta blocker medication’, and in the [current value] field of Data Point 1 enters ‘metoprolol 10 mg per day’.

The user then moves to the Objective area 400d. The user enters the name ‘normal blood pressure’, and in the [current value] field of Data Point 1 enters ‘130/85’.

The user then selects the Save button 400e, upon which the system stores the experience named ‘treat high blood pressure’ in the users' personal experience database.

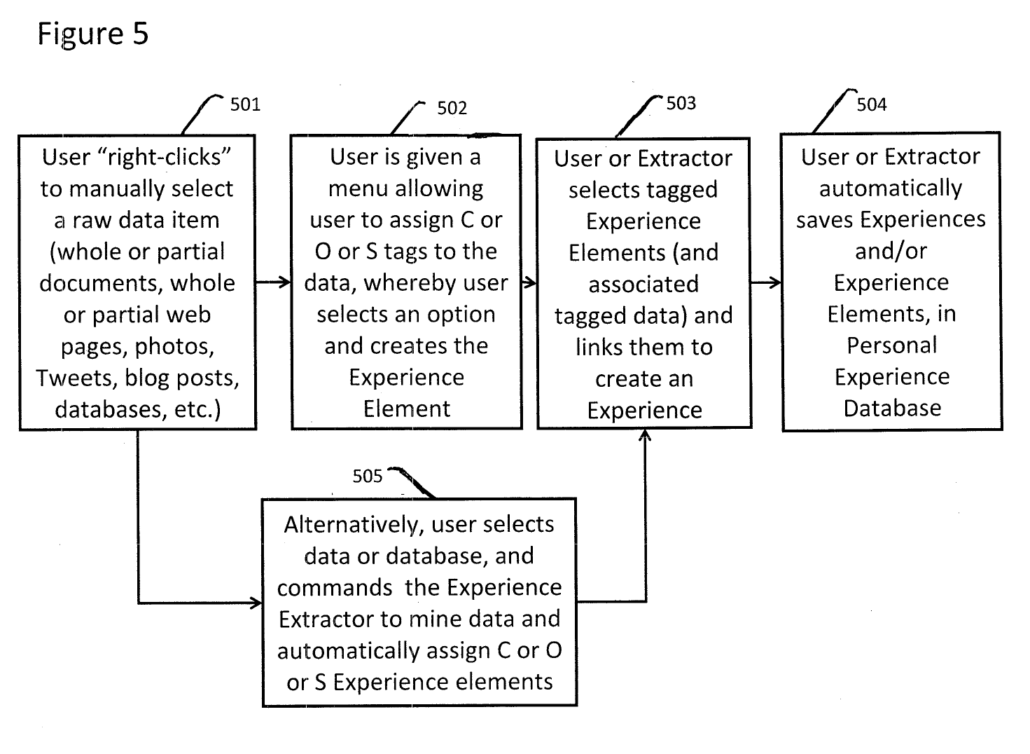

Multiple detailed flow charts of experience creation are available. For example, the user could create an experience with one, two or three of the experience elements completed. The user could explicitly enter data into each field, or alternatively as detailed below and described in FIG. 5 select data from external data sources, or alternatively select from a pull-down menu which has been populated with a list of values from which to choose, enabling the user to reuse values entered in previous experiences, or alternatively select from a set of options populated by taxonomies of potential values. Further, the user could specify multiple data points within each Condition, Strategy or Objective element, creating a multivariate definition of the element.

FIG. 5 illustrates an example flow chart in which the System allows user 201 to select and directly tag and associate raw data, versus explicitly creating the experience, and then connecting data to the experience as illustrated in FIG. 4. While using any multitude of computer applications such as word processors, document management systems, databases, web browsers, etc., the system provides the user the ability to select raw data 210a, 210b, 305 from a local or remote source such as a document, web page or external database, visible from within the display device 202. Using functionality provided by the Experience Modeler service 203 the user is able to select a specific file, data item or field in a database, in this example embodiment by using the right button of the computer mouse input device (called a “right click”), which opens a menu containing the options to use the selected data as a data point 400g within a Condition 400b, Objective 400c or Strategy 400d experience element 501. The user then selects one of the available options thereby tagging the selected data with a C, O or S tag as appropriate, creating an experience element 502, and indicating to the Data Linking service 214, 304 that a link to the selected source data needs to be maintained. The system then presents the user with the ability to select one more experience elements (tagged data), and then associate the experience elements into experiences 400a 503. The system then saves the experiences and their associated elements into the user's personal experience database 204 504.

Alternatively, the Experience Advisor System 200 can also automate the process of accessing, parsing and tagging data 210a, 210b, 305 using Experience Extractors 209 specifically written to integrate with and interpret multiple databases from which C—O—S Experiences are to be obtained 505. The system can then present the extracted experience elements to the user, or associate them automatically 503, and save them in the personal experience database 204, 504.

The links established by the Data Linking Service 214, 304 between the Experience Elements and their respective underlying data points 210a, 210b, 305 are associative, via such commercially available methods as subscription, in other words, associatively linked to the source data point so as to allow the Condition, Objective or Strategy Data Point value to change if the underlying data point changes.

In our current example embodiment, the Experience Advisor System 200 can apply an Experience Extractor 209 specifically written to be able to read and interpret the patient records stored in a specific hospital's patient record database and as maintained using that hospital's specific electronic medical record software application. The Experience Extractor 209, applying algorithms enabling it to parse the database, and recognize fields which contain data indicating potential Condition, Strategy or Objective data points, selects relevant matching data and tags the data with C, O or S tags 505. These automatically created experience elements are then optionally linked into complete experiences 503, and saved in the user's personal experience database 204, 504.

It is anticipated that Experience Extractors 209 will be created by the user, and/or purchased from 3^{rd} party authors, potentially as part of a 3^{rd} party application developer's application programming interface (API), and stored locally or accessed from external locations, from which 3^{rd} parties can make available specific extractors either at no cost, or for a fee.

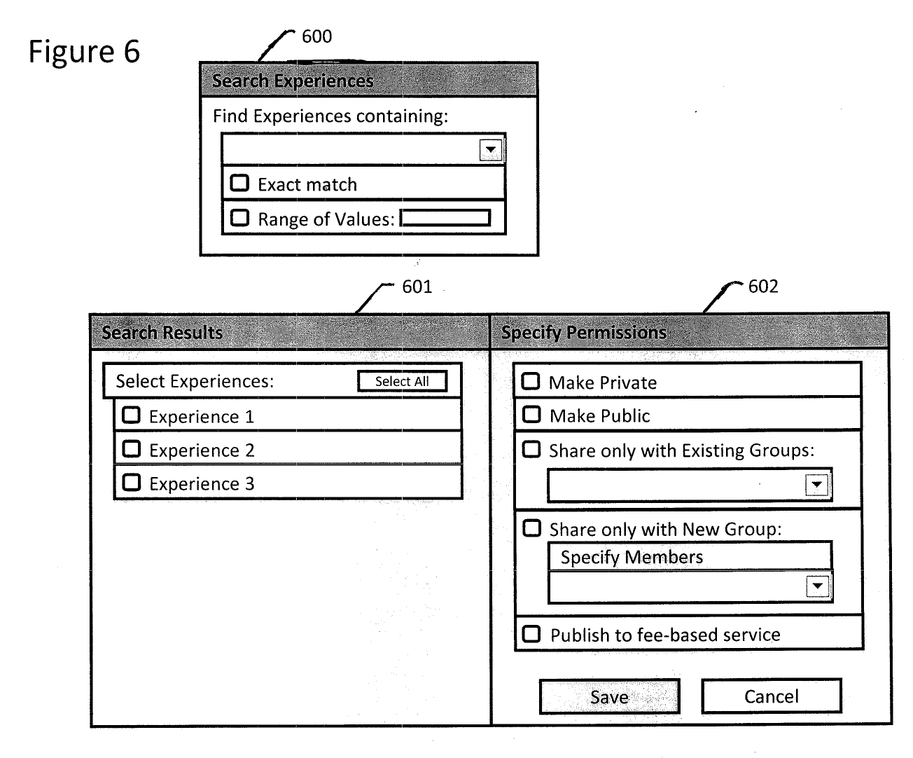

FIG. 6 illustrates an example set of user interface options provided by the system to allow the user to select and share experiences with others. In at least one embodiment (i) the system first provides the user with a menu 600 enabling the user to specify criteria to be used by the system to search for experiences from within the user's personal experience database 204. (ii) The system presents to the user that set of experiences returned from the search process, and allows the user to select from among the search results that set of experiences to which the sharing permissions are to be set 601. (iii) The system then presents to the user a list of options 602 from which the user may specify that the selected set of experiences are to be (a) set as private, indicating they are not to be shared, or (b) accessible to everyone, or (c) accessible to a predefined individual or group of individuals, such as explicitly identified individuals, or those individuals for which the user possesses appropriate encryption keys, or those individuals identified as friends, relatives, business associates or other groups in the user's contact management or social networking applications, or those individuals or groups who have registers for subscription services to access all or parts of the database, or (d) accessible to a new individual or group, upon which the system would provide to the user the ability to specify the members of the new group, or (e) published to a fee-based subscription service.

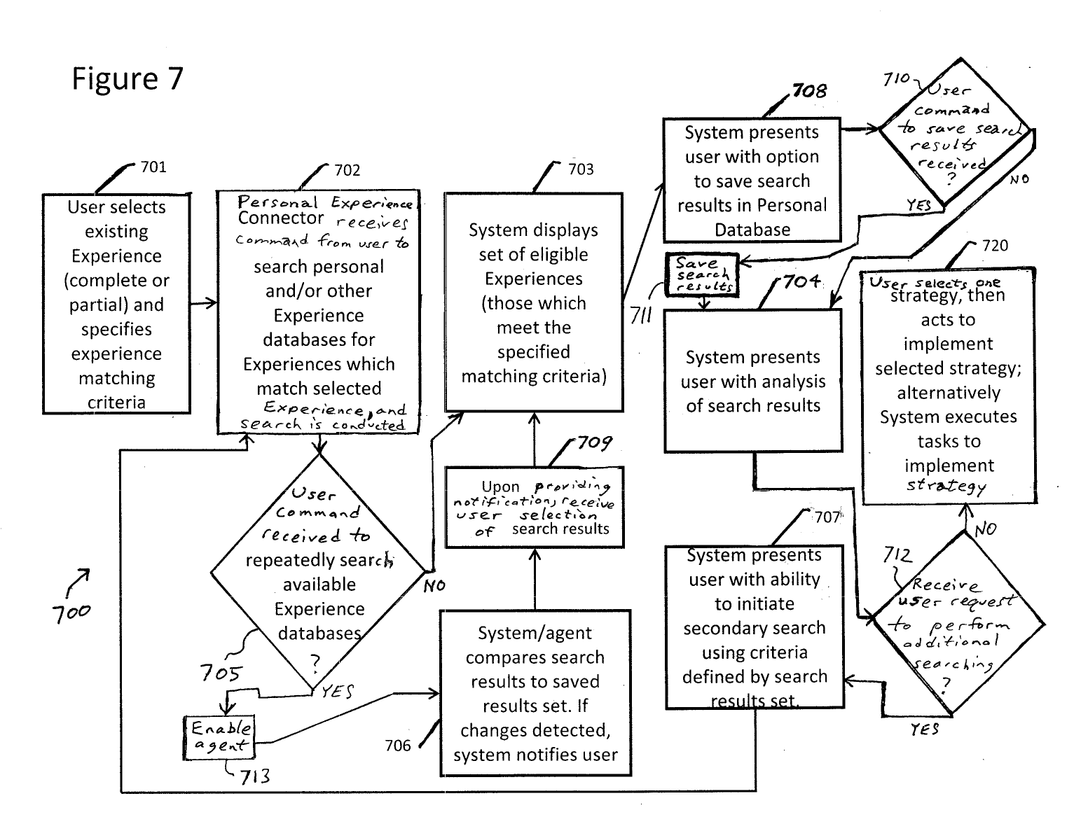

FIG. 7 illustrates an example flow chart 700 in which the Experience Advisor System 200 of FIG. 2 (or another embodiment of such a system) accepts a request from the user (e.g., the user 201 of FIG. 2) to search for experiences using user selectable criteria, displays the search results to the user, and then presents the user with options to analyze the results, save the results, initiate a secondary search, or execute tasks necessary to implement a preferred strategy. More particularly as shown, the process represented by the flow chart 700 begins at a step 701 at which the System 200 first enables the user to (i) specify an existing primary experience or create a new primary experience, then further enables the user to (ii) select the whole experience 301 or partial contents thereof 302, 303 to form the search criteria, and then allows the user to (iii) specify the criteria used to determine whether a second experience is a match with the specified primary experience 701. It should be appreciated that the step 701 particularly is intended to encompass both a circumstance where the user inputs a new primary experience that is then used (in whole or in part) as a basis for a search, as well as a circumstance where the primary experience used as the basis for a search (in whole or in part) is already available on the system.

Upon completion of the step 701, the system 200 then accepts a command from the user to search all experience databases for which the user has access, at a step 702, and conducts such a search. Depending upon the embodiment, the experience databases that are searched can include, for example, the personal experience database 204 of the system 200 as well as the databases 206a, 206b associated with the External Experience Connectors 206. Upon completion of the step 702, the process then at a step 705 determines whether a user command has been received to create an agent to repeatedly search available experience databases. If not, then, the process advances from the step 705 to a step 703, at which the System 200 then retrieves, assembles and displays the experience data resulting from the search (the search results). Alternatively, if such a user command is received at the step 705, then the process advances from the step 705 to a step 713 at which the System (specifically via the Agent Manager 207) enables the creation of a software agent to repeatedly execute the specified search, after which at a step 706 the System 200 (or agent thereof) compares the search results to search results from previously executed similar search executions as stored in the search results database 212. Further at the step 706, if an additional execution of the search results in search results that are different from past search results and one or more changes are detected, then at the step 706 the system 200 (or agent thereof) also provides a notification for receipt by the user that a difference was detected, and further at a step 709 the system 200 enables the user to select the new search results for display, at which point the process also advances to the step 703 and the system displays the selected search results. It should be understood that no notification occurs, and the process proceeds directly from the step 706 to the step 703, in the event that no changes are detected at the step 706.

Subsequent to obtaining and displaying the search result at the step 703, the system 200 at a step 708 provides the user with an option of saving the search results in a database such as the search results database 212. If at a subsequent step 710, the system 200 does receive a command to store the search results in such a manner as provided by the user, then the process stores the search results at a step 711 prior to advancing to a step 704. Alternatively, if at the step 710 no such command is received, then the process instead advances directly from the step 710 to the step 704. Regardless of the manner in which the process arrives at the step 704, at that step the system 200 next presents to the user (e.g., displays to the user via one of the display devices 202) an analysis of the search results, where the analyzing of the search results in at least one embodiment can be performed by way of the Analysis Plug-ins 213.

Upon displaying the search results at the step 704, the system 200 next provides the user with the ability (option) to initiate a further search process using search results as the search criteria at a step 712. In the event a user request to perform additional searching is received at the step 712, then the process returns to the step 702, thus repeating the search process. Alternatively, if at the step 712 no such user request is received (or if for some other reason the System 200 determines that no further searching is required), the process advances to a step 720. At the step 720, the System 200 additionally enables the user, upon reviewing the search results, to make a decision to select one of the displayed strategies as the preferred strategy, and make a decision to act in a manner indicated by that preferred strategy, or alternatively the System, in at least one embodiment by way of a software agent as maintained by the Agent Manager 207, executes actions to select a preferred strategy and/or execute tasks to implement the strategy 720. That is, at the step 720 either the user or the System 200 (e.g., an agent thereof) selects a strategy and implements the strategy by taking one or more actions, it being understood that such operation by the System 200 can occur automatically.

The process represented by the flow chart 700 of FIG. 7 can be practically implemented in many manners, in many contexts, and in many ways. For example, continuing with the example medical embodiment illustrated earlier, the user begins by selecting for example, those patients with high blood pressure at the step 701. The user specifies that the system should consider as a match any found experience containing at least one data point 303, contained within a Condition experience element 302, containing a blood pressure numerical value plus or minus 5 points from the user's selected experience. Upon executing the search at the step 702, should the system return a set of others' experiences having matched the user's initial condition of high blood pressure (Condition x), a doctor may, using a partial Experience including Condition x 701, perform a search at the step 702, assemble/display the search results at the step 703, and analyze the search results at the step 704 (e.g., by way of the Analysis Plug-ins 213), where the search results can for example be the set of C—O—S Experiences of other individuals who had a common blood pressure condition (Condition x).

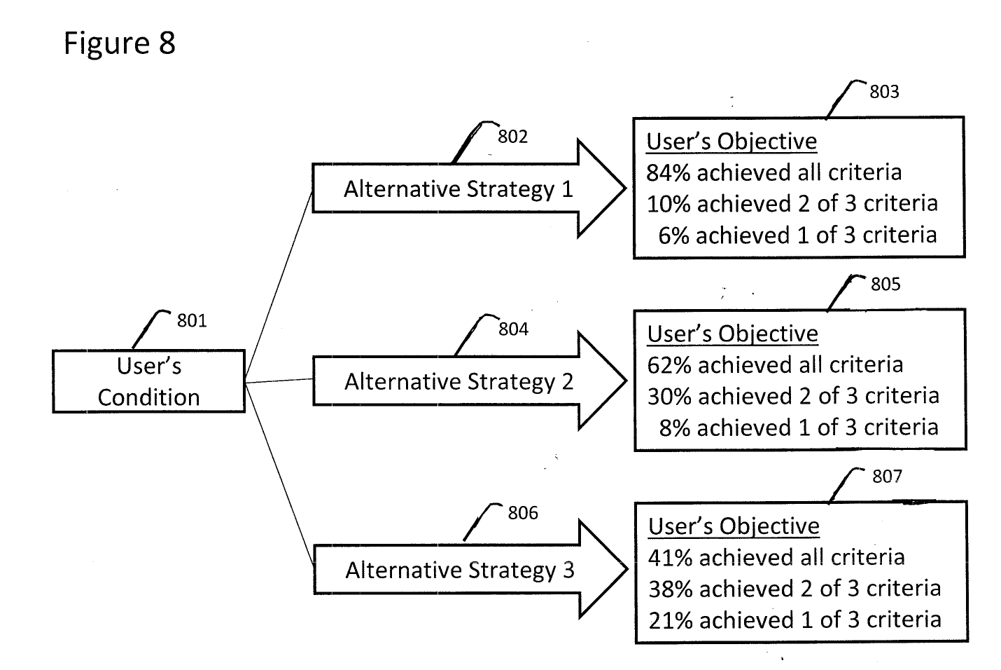

FIG. 8 illustrates a schematic diagram of one example embodiment of how the results of a given search and analysis could be displayed to the user (indeed, FIG. 8 can be considered to be representative of an example screen shot of a user interface display screen). In this example, the analysis provided to the user 201 by the System 200, as performed by one or more Analysis Plug-ins 213 would include displaying the Condition specified by the user 801 as the basis for the search criteria of the step 701. The displayed search results would then also include the set of Strategies 802, 804, 806 contained within the set of Experiences returned by the search. The display would also include, for each Strategy contained in the search results, the percentage of those users whose Objectives met or partially met the user's Objective 803, 805, 807.

To illustrate using our example medical embodiment, in this analysis the doctor can determine which treatment Strategy, for example a drug therapy, or other medical procedure, would be most desirable for his particular patient, based on the comparative set of Strategies 802, 804, and 806 and their respective outcomes Objectives 803, 805 and 807, respectively achieved via those Strategies, for that set of other patients who presented with the exact same condition as the patient. The doctor would then recommend that preferred Strategy to the patient.

Referring to FIGS. 7 and 8, and continuing with this example medical embodiment, if the doctor chooses to create an agent at the step 705 to repeat the specified search of the step 701, and thereby repeatedly monitor a population of other's experiences for changes in typical outcomes, the system compares the repeated search results to the saved or baseline search result of the step 706 (which can be stored in the database 212). If the agent detects a change the percentage of people employing a given strategy who achieved the target objective 803, 805, 807, the agent notifies the doctor of the change in results at the step 709, whereupon the doctor may choose to re-analyze the new results. Optionally, based on the change in results exhibited by the searched population, the doctor can choose to recommend a new strategy to those patients who presented with the given condition.

If a new strategy, Strategy b, is found to be superior, the system presents the doctor (who is in this case the user 201) the option of re-executing the search using selected elements of the search results as the search criteria at the step 712, returning to the doctor a list of patients who have Condition x and are currently employing the now obsolete Strategy a, and enabling the doctor to notify the found set of patients to change to the newly selected Strategy b. In this way, users who can benefit from changes in state-of-the-art strategies can be identified, notified, and given an opportunity to utilize the new Strategy b.

In this way, expert advice and recommendations are created by organically deriving statistical summaries of others' actual behaviors, from the actual experiences of a population of individuals, as opposed to reliance on expert reviews or the opinions of a single human restaurant reviewer, editor, or advertising or other promotions, which may or may not be reliable or authentic.

A user such as the doctor in our currently illustrated example embodiment will then have the ability to review the search results at the step 703, and make a decision to act based on the information presented to the user at the step 720. In this example embodiment, should the doctor receive search results indicating that a specific dosage of a specific medication (Strategy x) has, in the experiences of that population of other users obtained and analyzed in the search results, resulted in the largest percentage of patients having their blood pressure returned to normal with no side effects (Objective x), the doctor can make a decision to act on that strategy by prescribing to his/her patient the specific dosage of the specific medication indicated by the preferred strategy, Strategy x. Alternatively, the system 200 provides the doctor, via a software agent as stored in the Personal Agent database 208 with the option to electronically create and send to the patient's preferred pharmacy (which action can be considered part of the step 720).

It will be understood that although only some of the steps 701-720 of the flow chart 700 of FIG. 7 are mentioned above with respect to the above-discussed example, others of the steps of the process represented by that flow chart also are performed, at least depending upon the operational circumstance. Additionally, it should be understood that in other embodiments the process represented by the flow chart 700 of FIG. 7 can be performed in a modified manner that includes one or more additional steps instead of, or in addition to, the steps shown, or in which one or more of the steps shown are not performed. Also, the ordering of steps can be changed from that shown, and/or in some embodiments one or more of the steps shown can be performed simultaneously. For example in this regard in another embodiment, the step 708 can be performed at the same time as the step 704 is performed.

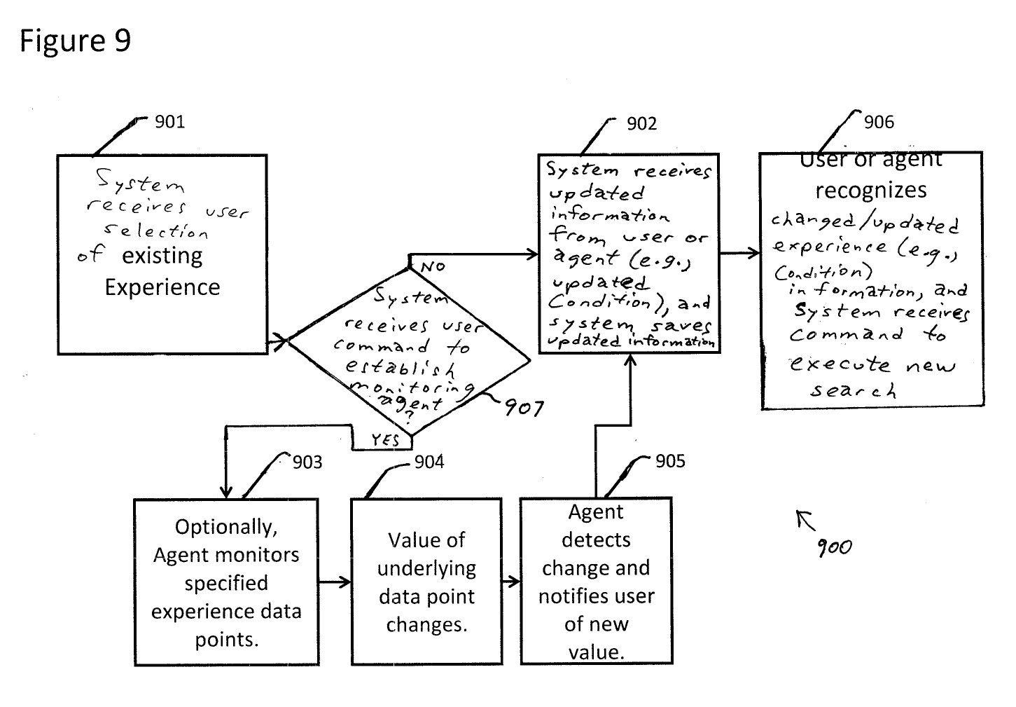

FIG. 9 is a flow chart 900 illustrating steps of an example process in which, in at least one embodiment, the value of an experience's underlying data point changes, and the system 200 re-executes a search based on detecting the change. As such, the process of FIG. 9 can be in at least some circumstances be a process that precedes the performing of the process of FIG. 7 concerning the execution of a search (or searches). That said, the process of FIG. 7 (or variants thereof) can be performed in a variety of circumstances and need not be preceded by the performing of the process of FIG. 9.

Further with respect to FIG. 9, the process represented by the flow chart 900 begins at a step 901 at which the system 200 provides the user 201 with the ability to select an existing experience 301 from within the user's personal experience database 204, and to further select any of the data points 303 contained within the experience. Selection of the experience 301 and/or data point(s) 303 therewithin can be achieved using a method of interaction similar to the method used to create a new experience as described with respect to the menu 400 of FIG. 4. The step 901 can be considered to be completed once the system 200 has received an appropriate selection. Upon completion of the step 901, the system at a step 907 determines whether a user command to establish a data point monitoring agent has been received. If not, the system 200 then proceeds from the step 907 directly to a step 902, at which the system presents the user 201 with the ability to edit the data point (or data points) 303 by entering a new value (or values) for the data point. Upon receiving edited/updated data point information (e.g., an updated value of a Condition), the system saves the edited/updated information, further as part of the step 902, for example in the personal experience database 204. The saving of the edited/updated information can in at least some embodiments involve saving of an edited/updated experience that reflects edited/updated data point information.

Alternatively, if the command to establish a data point monitoring agent is determined to have been received at the step 907, then the process advances from the step 907 to a step 903, at which an agent is created via the Agent Manager service 207 for the purpose of monitoring the value of the selected data point(s) selected at the step 901. Should the value of the data point(s) change 904 in comparison to the existing saved experience, the agent recognizes the change in value and notifies the user of the change at a step 905. Further following the step 905, the process also advances to the step 902 already mentioned above, at which the system 200 automatically updates the value(s) and saves the updated experience or experience portion(s) (e.g., the updated data point(s)).

Upon completion of the step 902, the process further advances to a step 906, at which either the user 201 or the System 200 (e.g., an agent such as the agent established at the step 903) recognizes the change in the saved experience. In at least some circumstances, the system can again provide the user with a notification of the changed experience information (e.g., a Condition data point). Upon a user being notified, the system then affords the user with an opportunity to command that a search be executed (or possibly re-executed) based upon the new experience information (e.g., Condition data point). Such a command can form the basis of commencing a search, and thus for example in some embodiments the step 906 could then be followed by the step 702 of FIG. 7 (the step 701 can be skipped in this circumstance, since in this circumstance the experience portion serving as the basis for the search would already have been specified). Further referring to the step 906, as noted, in some embodiments or circumstances where an agent has been created and is involved with the process (e.g., created in response to the step 907) the agent automatically recognizes the changed/updated experience information and commands the system to execute (or re-execute) a search based upon that information. Operation of the agent at the step 906 could in some embodiments then further be supplemented by additional agent operation such as that of the step 706 of FIG. 7 and, in some circumstances, the agents operating in the process 700 and process 900 can be one and the same agent.

To further illustrate the processes represented by the flowcharts 700 and 900 contained in FIGS. 7 and 9, an additional example can be provided relating to attending a music performance. In this regard, one can suppose that the user 201 uses the Experience Modeler 203 to create the Objective of attending a music concert in which a specific band, Band X, is to perform, and includes in the Objective 400d a data point 400g indicating that the venue in which the performance will be held must be located within 100 miles of the user's location (as already noted, inputs by the user can be provided via a user interface such as the menu 400 of FIG. 4, and thus reference is made to FIG. 4 in this regard). The current Condition 400b contains a data point 400g specifying the user's current location, and via the Data Linking Service 214, 304 the user specifies that the source of the location value is an external data source 210b, 305, namely, GPS coordinates obtained from the user's mobile phone. In this circumstance, it is possible for the user to initiate a search based upon the existing experience, in accordance with FIG. 7. That is, the user 201 can instruct the system 200 to search for others' Experiences in accordance with the step 702 (see FIG. 7), and subsequently search results are displayed at the step 703 and analyzed at the step 704 (also see FIG. 7). Further for example, upon receiving of (the user being presented with) the analyzed search results at the step 704, the user 201 can conclude that there are no Strategies available (e.g., there is no scheduled performance of Band X at a venue within 100 miles of user's current location) that will meet the Objective (attending a performance by Band X, within 100 miles of user's current location), given the current location Condition, as indicated by the user's GPS-enabled mobile phone.

Notwithstanding the above discussion, it should be further appreciated that the process of FIG. 9 can be applicable to this circumstance, particularly insofar as the Condition data point underlying the search and analysis, namely, the position of the user 201 as indicated by the GPS information, can change with time. Thus, in addition to the above, the system 200 in the present example also presents the user 201 with the ability to create an agent, as commanded via the step 907, via the Agent Manager 207. Upon the agent becoming operational, ongoing and repeated operation by the agent to search for a Strategy that satisfies the Objective in accordance with the process of FIG. 7 is repeatedly triggered as changes occur with respect to the value of the underlying data point (namely, user's location 400g) as monitored by the agent in accordance with the steps 903-905. For example, upon detecting, via the Data Linking Service 214, that the GPS location information has changed at the step 905 (following such a change occurring at the step 904), then the system 200 saves/updates the information at the step 902. Additionally, at the step 906, the agent causes a search to be executed and/or, if the search was already performed before, re-executed, in accordance with the search process (or portions thereof) shown in FIG. 7. More particularly in this regard, further for example, if the user has traveled to a different city, the agent will recognize a change in a data point (location) 400g at the step 905 (in this case underlying a Condition data point), the agent automatically will detect and save the user's new location as the new city at the step 902, and the agent can then repeat the search at the step 906 (with the search possibly proceeding in accordance with the one or more of the steps of FIG. 7) to determine and output to the user Strategies which satisfy the new Condition and existing Objective. Thus, additionally for example, the agent can recognize that Band X has a performance scheduled at a venue in the new city, and then advise the user that there is a new Strategy which is now available for review (venue within 100 miles of user's present location), which can be understood to correspond to the step 704 of FIG. 7. The user in turn can act to implement a selected strategy and/or the system can execute task(s) to implement a selected strategy, in accordance with the step 720 of FIG. 7.

In this way the System 200 enables data and information to repeatedly self-organize based on the changing, current, specific needs of the user, thus creating real-time context dependent knowledge.

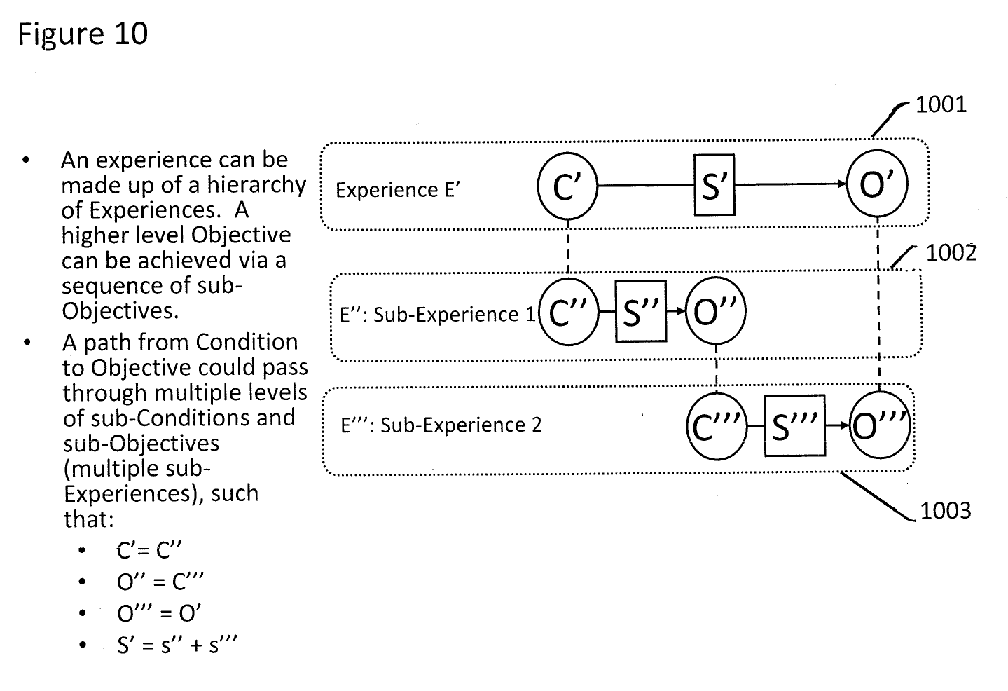

FIG. 10 is a schematic diagram representing one specific instantiation of a larger or higher level Experience, E′ 1001, being a nested experience, decomposed into two sub-Experiences, E″ 1002 and E′″ 1003. In this example embodiment, an experience beginning with Condition C′, and implementing Strategy S′ to achieve Objective O′ 1001, can be subdivided into two sub-experiences 1002, 1003. In this example, C″, the Condition of sub-experience E″ 1002, is identical to C′, the Condition of the higher level experience E′ 1001. Further, O″, the Objective of the first sub-experience E″ 1002 is identical to C′″, the Condition of the second sub-experience E′″ 1003. Finally, O′″, the Objective of the second sub-experience E′″ 1003, is identical to O′, the objective of the higher level experience E′ 1001. S′, the Strategy of the higher level experience E′ 1001 is therefore equivalent to the sum of the two sub-experience strategies, S″ and S′″ 1002 and 1003, respectively. The Experience Modeler 203 creates and maintains the links between primary 1001 and associated sub-experiences 1002, 1003.

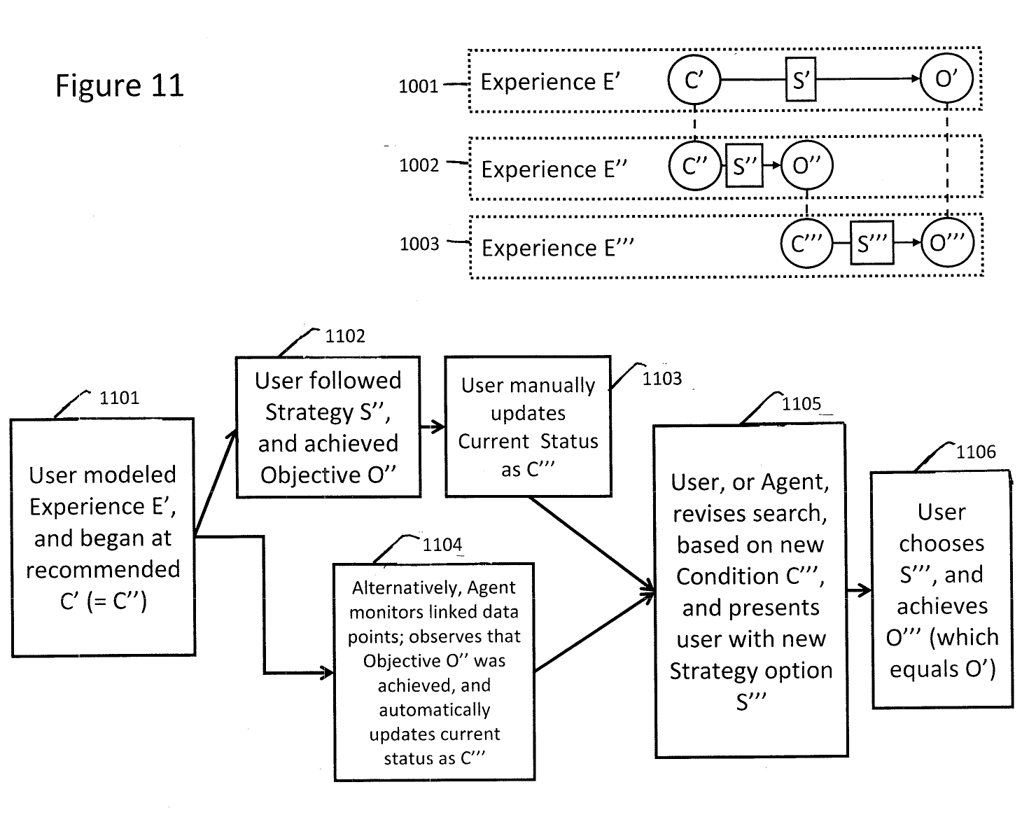

FIG. 11 illustrates a flow chart of at least one example embodiment in which the system interacts with the user providing preferred strategies in the case of a nested experience. The user interaction refers to the example schematic diagram of Experiences E′, E″ and E′″ from FIG. 10 1001, 1002, 1003, respectively, restated in FIG. 11 for convenience. The System 200 has enabled a user to model the Condition C′ and Objective O′ of experience E′ 1001, using an interaction model as illustrated previously in FIG. 4, 1101. User is presented with a set of available strategies (as illustrated in FIGS. 7 and 8), and then selects and follows Strategy S″, thereby achieving Objective O″ 1102. Using flow chart and processes illustrated previously in FIG. 9, user's current experience is updated with a new condition, C′″ 1103. System then enables user to repeat search based on updated Condition (C′″), and presents user with new Strategy S′″ 1005. User selects Strategy S′″, and achieves objective O′″, being identical to Objective O′, thereby completing the second sub-experience E′″ and the higher level experience E′. Alternatively the system provides user the ability to create an agent 903, which monitors the underlying data points of user's condition, and, detecting that the user's condition as changed to C′″ 1104, repeats the previous search 906 and recommends the new Strategy S′″ 1105.

An example embodiment of how the system interacts with a user in the case of a nested experience can be illustrated by the example of purchasing a car. The initial Condition (C′) can be described in at least one embodiment via the Experience Modeler 203 using a multivariate Condition element containing such data points as ‘old car totaled in accident’, and location 1001. The Objective (O′) can then be described using a multivariate set of data points such as ‘monthly payment not to exceed $300’, and preferences for features such as safety rating, size, performance, miles per gallon, and/or others. Then, using the Experience Connector 205, the user can search for others' Experiences 702 that shared similar Conditions and Objectives, analyze those experiences using Analysis Plug-ins 213 and present the results to the user 201, 703 via the Experience Advisor user interface 202.

In our example embodiment, let us presume that the System 200 presents results to the user indicating that the vast majority of people who, starting with Condition C′ and Objective O′, had achieved their Objective by employing a two phase strategy of first searching for available car models that met the user's needs (S″), and then once the desired new car model was selected (O″), the user then searched for and selected the best dealer from which they purchased the car (S′″). In this case, the preferred Strategy is a two-phased Strategy 1002, 1003. Based upon the highly variable set of outcomes which can result from the first sub-experience 1002, the Condition for the second sub-experience is impossible to predict ahead of time, and therefore the primary Strategy S′ 1001 must be divided into two separate Strategies, S′ and S″, the second being conditional on the results of the first 1002, 1003.

As an alternative example, the Experience Advisor could also have found and displayed to the user experiences of other individuals who did not search for the preferred car model first and went directly to the closest dealership to select and purchase a car, and in those cases, could have found a larger percentage of these individuals' experiences having resulted in not meeting their monthly payment objective, or their safety rating Objective. Based on this comparative analysis, the user in our example selected the Strategy (S′), made up of a composite of two Strategies (S″ and S′″), which was used by the largest number of individuals who achieved their original Objective (O′).

In this example, the initial Condition (C′) for the overall Experience 1001, is identical to the initial Condition (C″) of the first sub-Experience 1101, 1002. The user then executes Strategy S″ and achieves Objective O″ 1002, by selecting the car model they will purchase 1102. At this point, the user interacts with the Experience Modeler 203 to indicate that Objective O″ has been achieved 1103. The System 200 then automatically updates the user's current Condition as C′″, and recommends Strategy S′″ 1105, select a dealer 1003, as the best strategy to achieve the original Objective (C′) of purchasing a new car.

The user then searches for local dealers who sell the selected car model 1003. Based on the user's preferences a dealer is chosen which achieves the last sub-Objective (O′″) 1106, 1003. For purposes of simplicity, we will not model the negotiation or financing processes that are typically involved in buying a car, although a more complex set of sub-experiences could model these needs, and conclude that we have now achieved our original Objective O′ 1001 by achieving the final sub-objective O′″ 1106, 1003.

The example embodiments presented so far refer to a specific analysis case in which the Condition and Objective are known, and the user seeks to obtain the most effective strategy available. Other problems exist for which a different set of known and unknown variables exist. As alternative embodiments for which the System 200 has been designed to support:

i. User can model an Experience in which the Condition is known, and search for other Experiences with similar Conditions, to determine what Objectives have been achieved in others' Experiences starting from that Condition; and alternatively the Strategies that were used to achieve the indicated Objectives; OR

ii. User can model an Experience in which the Condition is known, and search for other Experiences with similar Conditions, to determine what Strategies were employed in others' Experiences starting from that Condition, and alternatively what Objectives were achieved via each Strategy; OR

iii. User can model an Experience in which the Objective is known, and search for other Experiences with similar Objectives, to determine what Strategies were employed in others' experiences which achieved that Objective, and alternatively the Conditions from which others' Experiences began; OR

iv. User can model an Experience in which the Objective is known, and search for other Experiences with similar Objectives, to determine from what Conditions others' experiences began, and alternatively the Strategies that were employed to achieve the Objective;

v. User can model an Experience in which one or more of the Experience Elements are incomplete, as exhibited by an incomplete list of data points contained in one or more of the Experience Elements, and can search for other similar Experiences which share common data points as the user's current Experience, to ascertain whether other users' common Experience Elements also contain other data points, then consider whether to add the additional data points to completely describe the Experience element, and obtain more relevant comparative Experiences and be able to conduct more relevant analyses.

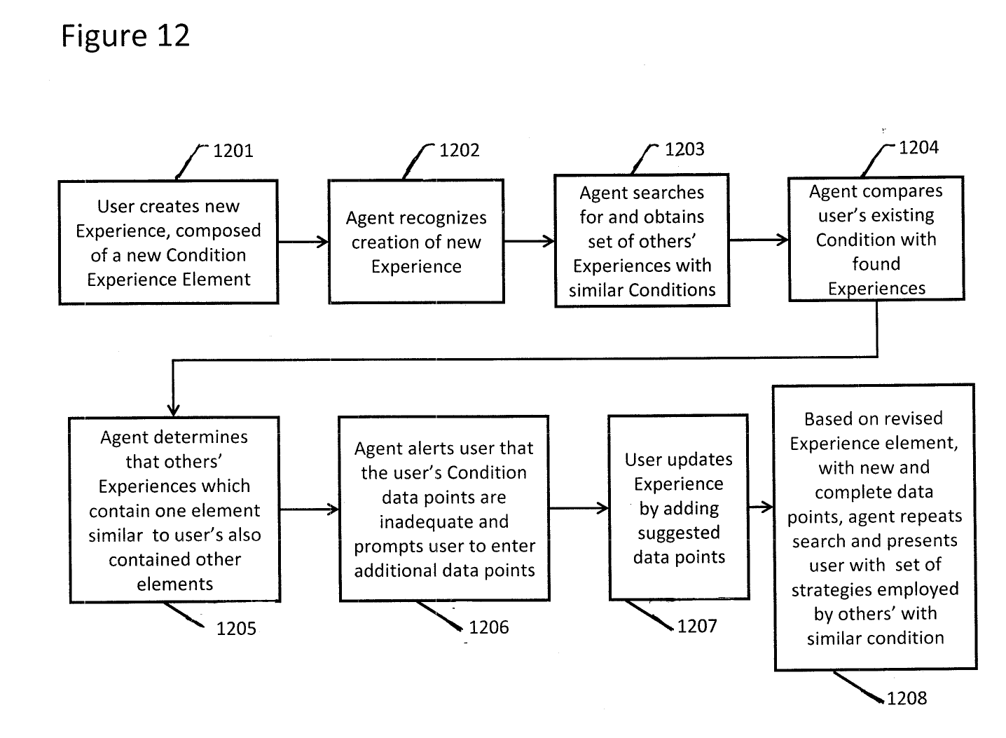

FIG. 12 illustrates an example embodiment flow chart of the last analysis case listed above (v). User creates a new experience composed of a condition element containing one data point 1201, and saves the experience. An agent created for this purpose recognizes the creation of a new experience 1202, initiates a search for, and obtains a search result composed of a set of others' experiences which contain a condition element containing the same data point name as the user's original experience 1203. Agent then compares user's existing condition with those of the search results set 1204, and determines that the conditions contained in the search result set also contain other data point types not contained in the user's original condition 1205. System 200 alerts user that the user's existing experience is insufficiently described, and prompts user to add additional condition data points so as to be able to completely describe the user's condition. User edits the existing experience, adding data points as recommended by the agent 1207, and saves the updated experience. System 200 then presents the user with the ability to execute a new search based on the newly edited condition, and obtains a search result comprised of a set of other's experiences 1208.

To illustrate this flow chart with an example embodiment, a user 201 purchases a pre-owned home. Not being an expert in home maintenance, the user may not know that specific components of the home he purchased, such as the water heater, furnace, roof, or dishwasher, have limited life spans. Further, the user may not know that allowing the water heater to fail can allow water to escape into the finished basement causing substantial damage to the home. In other words, the user doesn't know what he doesn't know. He does not know he has a potential problem because he does not know that water heaters have limited life spans, and that failure is costly.

In this example embodiment, the user 201 can engage with the System 200 and using the Experience Modeler 203 describe the current Condition as ‘purchased pre-owned home’. The user has not specified a sufficient set of data points, only entering one data point (‘purchased pre-owned home’), because he does not know that water heater age can be an issue. The agent searches for the set of common Experiences, and compares the user's Experience to the set of those obtained via search 1203, 1204. The agent identifies a set of Condition data points including ‘age of water heater’, that are often included in others' Conditions 1205. The agent alerts the user via email or screen alert or text message, recommending that the user revise an existing Experience 1206, and suggests a list of Condition data points that were commonly used in others' experiences. The user obtains the data, and enters the data 1207 via the System 200, and saves the refined experience. In our example, let's assume the user's water heater is 20 years old. The agent, recognizing a modified Experience in the Personal Experience Database 204, repeats the search and obtains a list of Strategies typically chosen by people with the Condition of having a 20 year old water heater. Based upon this input, the system returns a resulting set of strategies indicating that the vast majority of individuals with that condition adopt a strategy to replace their water heater.

In at least some embodiments, this method of analysis allows organically derived data and information to be gathered, organized, and applied directly to a person's situation, even advising the user of problems which the user cannot have otherwise known were present.

In at least some embodiments, using these agent-based process, the C—O—S Experience Model 100, together with the methods and apparatus disclosed herein, create a system 200 that automatically obtains data, automatically associates data into information, and automatically organizes it in a way directly relevant to a user's needs, thereby enabling the user to not only solve known problems, but be made aware of problems of which the user was not previously aware.

The C—O—S System enables information to self-organize in a way specifically relevant to the user's specific and changing needs and intent, thereby automating the production of knowledge.

Many applications of the invention will become apparent to individuals and companies upon exposure to the C—O—S Experience Advisor methods and apparatus. As such, the examples and analysis methods presented herein are not intended to limit the range of applications to which the invention can be applied in the future.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A method of developing knowledge, the method comprising:
receiving at a computer system first information provided by at least one actor identifying a plurality of primary elements;
receiving at the computer system second information provided by the at least one actor, wherein the second information categorizes each of the primary elements as having a respective primary attribute;
receiving at the computer system third information provided by the at least one actor, wherein the third information establishes relationships between at least some of the primary elements so as to define one or more primary experiences,
wherein each of the primary experiences includes respective first, second, and third ones of the primary elements and is representative of a respective movement or progression between the respective first of the primary elements to the respective second of the primary elements via the respective third of the primary elements, and
wherein the respective primary attribute of each of the first primary elements is a respective condition attribute, wherein the respective primary attribute of each of the second primary elements is a respective objective attribute, and wherein the respective primary attribute of each of the third primary elements is a respective strategy attribute; and
storing the one or more primary experiences within a database at least indirectly associated with the computer system.

2. The method of claim 1, further comprising:
determining a recommendation regarding one of a strategy option, a condition option, and an objective option based upon an analysis of the one or more primary experiences, one or more additional experiences, or one or more portions thereof; and
causing a performing of at least one operation at least indirectly based upon the recommendation.

3. The method of claim 2, wherein the performing includes a sending of a signal to an external location intended to cause a further operation to occur.

4. The method of claim 1, wherein one or more of the first information, the second information, and the third information is provided from an experience extractor that is a first actor of the at least one actor.

5. The method of claim 4, wherein the experience extractor is at least indirectly in communication with one or both of a local data source and an external data source, from which the experience extractor receives at least some of the first information, the second information, and the third information.

6. The method of claim 5, wherein the experience extractor one or more of: (a) processes received data to determine at least some portions of the received data that constitute ones of the primary elements; (b) tags each of the primary elements with a respective attribute tag signifying whether the respective primary attribute of each respective primary element is the condition attribute, the strategy attribute, or the objective attribute; (c) automatically operates to establish the relationships.

7. The method of claim 1, further comprising making the plurality of primary experiences stored within the database accessible to at least one third party on a free or fee-based basis, wherein the database is a personal experience database and the at least one actor includes a user or user computer from which the first and second information is received.

8. The method of claim 7, wherein the computer system receives from the user a selection for sharing one or more of the set of primary experiences based at least in part upon user specifiable rules, and grants permission to one or more entities based upon the rules, the one or more entities including at least one of one or more individuals, one or more groups, and one or more corporate entities.

9. The method of claim 1, further comprising:
receiving at the computer system an input indicative of at least one portion of a secondary experience;
searching the database to achieve a search result including at least one part of one or more of the primary experiences having at least one of the primary elements that is identical or substantially similar to at least one secondary element of the at least one portion of the secondary experience;
analyzing the search result; and
providing an output for receipt by the at least one actor, the output being based at least in part upon the analyzing of the search result.

10. The method of claim 9, wherein the output includes either a recommendation or a signal, wherein the signal is configured to cause an action to be performed by the at least one actor.

11. The method of claim 10, wherein (a) the at least one actor includes a first actor from which the first information is received and a second actor that performs the action; or (b) the at least one actor includes at least one of one or more human beings, one or more computer systems, one or more agents, and one or more other entities.

12. The method of claim 9,
wherein each of the at least one secondary element has a respective secondary attribute that is either a respective condition attribute or a respective objective attribute, and thus each of the at least one of the primary elements of the at least one part also has a respective primary attribute that is either a respective condition attribute or a respective objective attribute;
wherein the search result additionally includes one or more additional ones of the primary elements each having a respective primary attribute that is a respective strategy attribute; and
wherein the analyzing of the search result includes analyzing the one or more additional ones of the primary elements to determine at least one preferred one of the primary elements corresponding to a preferred strategy, and wherein the output at least indirectly identifies the at least one preferred one of the primary elements or the preferred strategy.

13. The method of claim 9,
wherein each of the at least one secondary element has a respective secondary attribute that is either a respective condition attribute or a respective strategy attribute, and thus each of the at least one of the primary elements of the at least one part also has a respective primary attribute that is either a respective condition attribute or a respective strategy attribute;
wherein the search result additionally includes one or more additional ones of the primary elements each having a respective primary attribute that is a respective objective attribute; and
wherein the analyzing of the search result includes analyzing the one or more additional ones of the primary elements to determine at least one preferred one of the primary elements corresponding to a preferred objective, and wherein the output at least indirectly identifies the at least one preferred one of the primary elements or the preferred objective.

14. The method of claim 9,
wherein each of the at least one secondary element has a respective secondary attribute that is either a respective strategy attribute or a respective objective attribute, and thus each of the at least one of the primary elements of the at least one part also has a respective primary attribute that is either a respective strategy attribute or a respective objective attribute;
wherein the search result additionally includes one or more additional ones of the primary elements each having a respective primary attribute that is a respective condition attribute; and
wherein the analyzing of the search result includes analyzing the one or more additional ones of the primary elements to determine at least one preferred one of primary elements corresponding to a preferred condition, and wherein the output at least indirectly identifies the at least one preferred one of the primary elements or the preferred condition.

15. The method of claim 9, wherein the analyzing of the search result includes analyzing the at least one of the primary elements so as to evaluate a plurality of alternative courses of action, and wherein the output relates to at least one recommendation as to one or more of a desirability, an effectiveness, or an attractiveness of at least one of the alternative courses of action having one or more of at least one associated condition, at least one associated objective, and at least one associated strategy.

16. The method of claim 9, wherein the input is indicative of an additional element of the secondary experience that has a respective condition attribute, wherein the analyzed search result is stored in the database, and wherein the analyzed search result includes information regarding degrees to which desired objective attributes have been historically achieved by way of one or more possible strategies.

17. The method of claim 9, wherein the searching of the database is performed automatically by way of an agent associated with the computer system.

18. The method of claim 17, wherein the agent further monitors an external data source, the computer system being in communication with the external data source by way of a data linking service.

19. The method of claim 9, wherein the computer system includes a personal experience connector by which the computer system is in communication with other external experience connectors, whereby the computer system is able to provide information concerning one or more of the primary and secondary experiences to third parties with which the external experience connectors are associated, or able to obtain information concerning additional experiences from the third parties with which the external experience connectors are associated.

20. The method of claim 1, further comprising:
receiving at the computer system an input indicative of a selection of one of the first experiences by the actor as a selected first experience;
receiving at the computer system a further input indicating an assignment of a particular condition attribute as a current status; and
storing within the database a modified version of the selected first experience that includes the particular condition attribute,
whereby a current state of the selected first experience is updated.

21. The method of claim 20 further comprising, upon the computer system receiving the further input or any other input indicating a change of the current status of the actor, automatically executing a search for one or more other experiences among the one or more primary experiences and one or more secondary experiences accessible from one or more external sources that have at least one other primary element that corresponds to the current status of the actor, whereby the computer system operates in a self-organizing manner.

22. The method of claim 1, wherein a first of the primary experiences includes a plurality of secondary experiences that in combination with one another form the primary experience, and wherein a secondary objective attribute of a first of the secondary experiences constitutes a secondary condition attribute of a second of the secondary experiences.

23. The method of claim 22, further comprising:
determining that the actor has followed a first secondary strategy attribute of the first secondary experience to arrive at the secondary objective attribute of the first secondary experience;
determining, by way of an agent, a second secondary strategy attribute that, if performed by the actor, should result in the actor achieving a further secondary objective attribute and thereby achieving a predetermined objective attribute of the primary experience.

24. The method of claim 1, further comprising:
comparing, by way of an agent, one of the primary experiences with at least one third party experience;
determining that at least one of the primary elements associated the one first experience is inadequate;
sending a message for receipt by the actor, the message intended to prompt a further input from the actor to modify the at least one of the elements;
modifying the at least one of the elements upon receiving the further input; and
performing a revised search by way of either the agent or another agent that is reflective of the modifying.

25. A computer system comprising:
a memory including at least one database;
at least one user interface; and
at least one processing device that is at least indirectly in communication with the at least one database and the at least one user interface;
wherein the computer system is configured to receive, via the at least one user interface, input information including first instructions to tag respective information items as being or including respective condition, strategy, or objective attributes, and second instructions to establish relationships among several of the attributes so as to define first experiences;
wherein each of the defined first experiences is stored in the at least one database, and is representative of a movement or progression from a respective condition attribute to a respective objective attribute via a respective strategy attribute; and
wherein upon the computer system receiving an additional input indicative of a second experience or portion thereof, the at least one processing device is configured to search the at least one database to achieve a search result including at least one of the one or more first experiences having at least one information item that is also found in the second experience or portion thereof, to analyze the search result, and to generate an output to be provided by the at least one user interface.

26. The computer system of claim 25, wherein the output is at least one of a recommended strategy, a desirable objective, or a plurality of strategy options or objective options from which a selection can be made.

27. The computer system of claim 25, wherein the at least one processing device performs at least one program so as to either establish at least one agent or perform functionality corresponding to at least one of a personal experience connector, an experience modeler, an experience extractor, an agent manager, and an analysis plug-in.

28. The computer system of claim 25, wherein the computer system further includes means for intercommunicating with at least one external data resource storing information relating to third party experiences or storing additional information items that can be tagged as condition, strategy, or objective attributes.

29. The computer system of claim 25, wherein the at least one processing device operates to maintain or determine a current user status as reflected by at least one of the experiences.

30. The computer system of claim 25, wherein the at least one database stores a plurality of data points associated with the attributes.

31. The computer system of claim 25, wherein the at least one processing device is further capable of outputting, via the at least one user interface, a plurality of strategies respectively accompanied by historic information indicative of extents to which the respective alternative strategies have resulted in a desired objective being attained, and wherein the preferred strategy is generated based upon a user input indicating a user selection of one of the alternative strategies.

32. The computer system of claim 25, further comprising means for communicating with an external device, wherein the computer system is configured to send automatically at least one signal for receipt by the external device so as to cause an action by the external device, the at least one signal being generated in at least in part based upon a recommended strategy, condition, or objective determined based upon the analyzed search result.
